(19) United States
(12) Patent Application Publication
(10) Pub. No.: US 2005/0062818 A1
(43) Pub. Date: Mar. 24, 2005

(54) Ink distributor

(75) Inventors: Hiroshi Hashi, Tokyo (JP); Masashi Matsuda, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/947,526

(22) Filed: Sep. 22, 2004

(30) Foreign Application Priority Data
Sep. 24, 2003 (JP) 2003-332129

(51) Int. Cl. B41J 2/19

(52) U.S. Cl. 347/92

(57) ABSTRACT

A plurality of bubble flow-regulating bubble paths are disposed in first and second distributor units of an image forming apparatus of an ink jet system; and bubbles mixed in ink liquids are collected by the flow-regulating bubble paths.

### CROSS-REFERENCE TO RELATED APPLICATIONS

This application is based upon and claims the benefit of priority from prior Japanese Patent Application No. 2003-332129, filed Sep. 24, 2003, the entire contents of which are incorporated herein by reference.

### BACKGROUND OF THE INVENTION

1. Field of the Invention

The present invention relates to, for example, an image forming apparatus of an ink jet system in which colors of ink liquids are ejected from a plurality of ink heads to form an image on an image forming medium, and relates to an ink distributor which distributes ink liquids to a plurality of ink heads.

2. Description of the Related Art

An image forming apparatus of an ink jet system has ink tanks by color, in which ink liquids of the colors black (K), cyan (C), magenta (M), and yellow (Y) are stored.

The respective ink liquids stored in the ink tanks are supplied to ink distributors through reservoir tanks. The respective ink liquids supplied to the ink distributors are distributed to ink heads.

If bubbles are mixed in the ink liquids supplied to the ink distributors, the ink liquids containing the bubbles are distributed to the ink heads. Therefore, a predetermined amount of each ink liquid is not ejected from the ink head, or the ink liquid is not ejected as set. To avoid this, the bubbles mixed in the ink liquids supplied to the ink distributors must be removed.

A technique of removing the bubbles from a buffer tank of an ink jet image forming apparatus is described, for example, in Jpn. Pat. Appln. KOKAI Publication No. 2003-80731. The following contents are described. An inner face of a ceiling wall of the buffer tank tilts by about five to ten degrees with respect to a horizontal face. A lower end (opening) of an ink inflow cylinder connected to a first ink channel is disposed in the vicinity of a bottom part of the buffer tank. A place of a discharge port connected to a second ink channel is set to be in a highest position. Ink circulates in the first ink channel, buffer tank, second ink channel, and a circulation path of a sub-tank from the sub-tank by driving a pump for circulating the ink. Accordingly, the bubbles in the buffer tank are collected on the side of the discharge port in the high position along a tilted ceiling face, discharged, separated by the sub-tank, and released to the atmosphere from an atmosphere release section.

### BRIEF SUMMARY OF THE INVENTION

According to a major aspect of the present invention, there is provided an ink distributor comprising: an ink distributor body which allows an ink liquid to communicate with at least one ink head that ejects the ink liquid and which accommodates the ink liquid and which supplies the ink liquid to at least one ink head; and a bubble flow-regulating bubble path which is disposed in the ink distributor body and which regulates a flow direction of bubbles mixing in the ink liquid.

### BRIEF DESCRIPTION OF THE SEVERAL VIEWS OF THE DRAWING

FIG. 1 is a whole constitution diagram showing an ink path of an image forming apparatus of an ink jet system to which one embodiment of an ink distributor of the image forming apparatus according to the present invention is applied;

FIG. 2 is a concrete top plan view of the ink distributor;

FIG. 3 is a concrete side view of the ink distributor;

FIG. 4 is a diagram showing a protruding direction of a substantially convex portion of each bubble flow-regulating bubble path in the ink distributor; and

FIG. 5 is a diagram showing another protruding direction of the substantially convex portion of each bubble flow-regulating bubble path in the ink distributor.

### DETAILED DESCRIPTION OF THE INVENTION

One embodiment of the present invention will be described hereinafter with reference to the drawings.

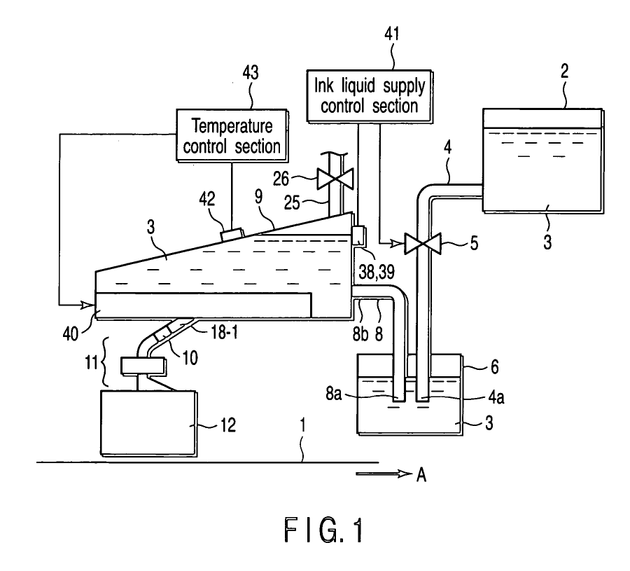

FIG. 1 is a whole constitution diagram of an ink distributor disposed in an image forming apparatus of an ink jet system. In the image forming apparatus of the ink jet system, a full-color image is formed on an image forming medium 1 using ink liquids of the colors black (K), cyan (C), magenta (M), and yellow (Y). FIG. 1 shows a peripheral constitution of an ink distributor which distributes at least one color of the ink liquid.

An ink tank 2 accommodates an ink liquid 3. The ink tank 2 is connected to an ink path tube 4. The ink path tube 4 is provided with an opening/closing valve 5. An upper end of the ink path tube 4 is connected to a bottom part side face of the ink tank 2, directed in a horizontal direction, halfway curved, and laid downwards. A lower end port 4a of the ink path tube 4 is disposed in a reservoir tank 6.

The reservoir tank 6 is disposed in a height position which is lower than that of the ink tank 2. Therefore, when the opening/closing valve 5 is opened, the ink liquid 3 stored in the ink tank 2 is supplied into the reservoir tank 6 through the ink path tube 4. The lower end port 4a of the ink path tube 4 is immersed in the ink liquid 3 stored in the reservoir tank 6.

In the reservoir tank 6, a suction port 8a of an ink liquid supply tube 8 is disposed.

The suction port 8a of the ink liquid supply tube 8 is immersed in the ink liquid 3 stored in the reservoir tank 6. The ink liquid supply tube 8 is extended upwards from the reservoir tank 6, halfway curved in a substantially horizontal direction, and laid. A supply port 8b of the ink liquid supply tube 8 is connected to an ink distributor 9.

The ink distributor 9 is disposed in an intermediate height position between the height positions of the ink tank 2 and the reservoir tank 6. Therefore, as the ink liquid 3 is supplied to the reservoir tank 6 from the ink tank 2 through the ink path tube 4, the pressure in the reservoir tank 6 rises. By the pressure rise in the reservoir tank 6, the ink liquid 3 in the reservoir tank 6 is supplied to the ink distributor 9 through the ink liquid supply tube 8.

A lower part of the ink distributor 9 is connected to at least one ink head 12 via an ink inflow channel 10 and a sealing mechanism 11. The ink head 12 ejects the ink liquid 3 by the ink jet system. FIG. 1 shows one ink head 12, because the drawing of a plurality of ink heads 12 is complicated.

A length of each ink channel constituted of the ink inflow channel 10 and sealing mechanism 11 is set to a present short channel length.

The respective ink heads 12 are fixed/arranged. The image forming medium 1, for example, a recording sheet is conveyed below the ink head 12, for example, in an arrow A direction at a constant conveyance speed. The ink head 12 ejects the ink liquid 3 onto the conveyed image forming medium 1.

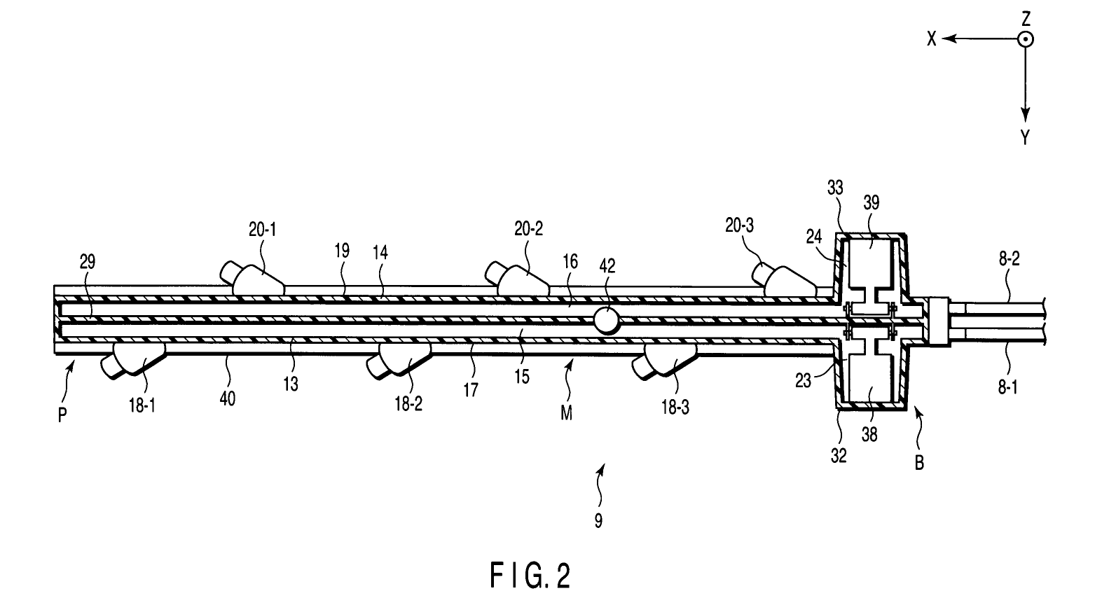

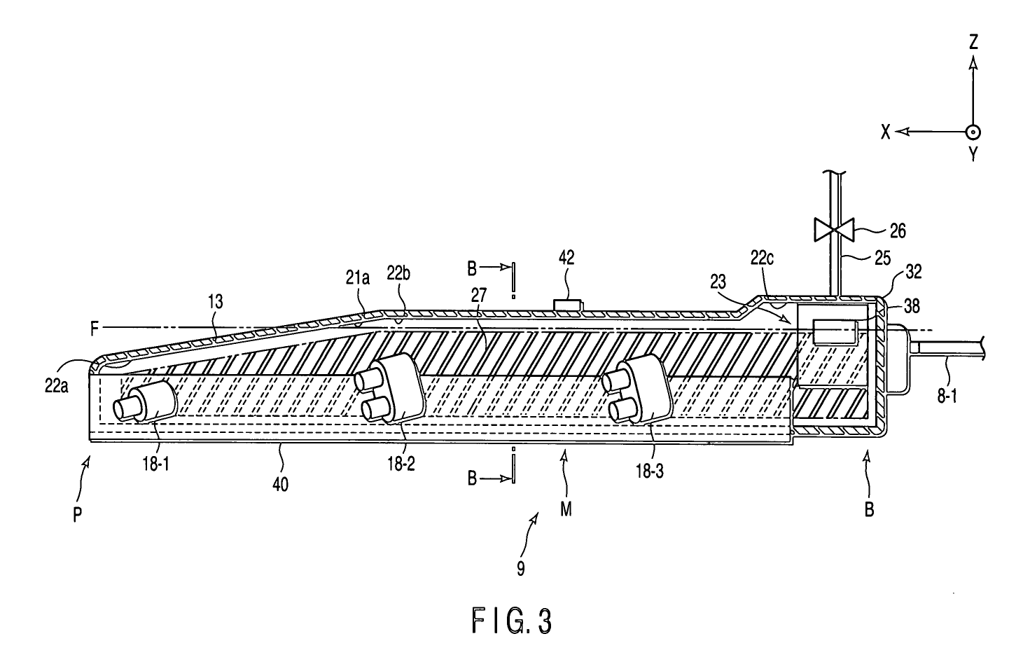

FIGS. 2 and 3 are concrete constitution diagrams of the ink distributor 9, FIG. 2 is a top plan view, and FIG. 3 is a side view. In the ink distributor 9, a back face 29 of a first distributor unit 13 is disposed opposite and parallel to that of a second distributor unit 14. The first distributor unit 13 and second distributor unit 14 are formed of resins.

A first body container 15 is disposed in the first distributor unit 13. The first body container 15 accommodates the ink liquid 3, for example, of black (K) (hereinafter referred to as the ink liquid 3K). A second body container 16 is disposed in the second distributor unit 14. The second body container 16 accommodates the ink liquid 3, for example, of yellow (Y) (hereinafter referred to as the ink liquid 3Y) which is different from the black (K).

For example, a group of three ink discharge port groups 18-1 . . . 18-3 are disposed in an outer side face 17 facing the back face 29 of the first distributor unit 13. The first distributor unit 13 distributes the stored ink liquid 3K to the ink discharge port groups 18-1 . . . 18-3. The respective ink discharge port groups 18-1 . . . 18-3 are disposed at constant intervals on the outer side face 17 of the first distributor unit 13. The respective ink discharge port groups 18-1 . . . 18-3 discharge, for example, the ink liquid 3K.

For example, three ink discharge port groups 20-1 . . . 20-3 are disposed on an outer side face 19 facing the back face 29 of the second distributor unit 14. The second distributor unit 14 distributes the stored ink liquid 3Y to the respective ink discharge port groups 20-1 . . . 20-3. The respective ink discharge port groups 20-1 . . . 20-3 are disposed at the constant intervals on the outer side face 19 of the second distributor unit 14. The ink discharge port groups 20-1 . . . 20-3 discharge, for example, the ink liquid 3Y.

Here, a thickness direction in which the first distributor unit 13 is disposed parallel to the second distributor unit 14 is regarded as a Y-axis direction.

A length of each of the first distributor unit 13 and second distributor unit 14 in an X-axis direction crossing the Y-axis direction at right angles is formed to be longer than that in a Z-axis direction (vertical direction).

Here, in the first distributor unit 13 and second distributor unit 14, a side connected to the ink liquid supply tube 8 is assumed as a base part B, and a side opposite to the base part B in the X-axis direction is assumed as a tip part P.

The ink liquid supply tube 8 has a first ink liquid supply tube 8-1 and a second ink liquid supply tube 8-2. The first ink liquid supply tube 8-1 is connected to the first distributor unit 13, and supplies the ink liquid 3K into the first distributor unit 13. The second ink liquid supply tube 8-2 is connected to the second distributor unit 14, and supplies the ink liquid 3Y into the second distributor unit 14.

Therefore, in the first ink liquid supply tube 8-1, an ink supply system of the black (K) constituted of the ink tank 2, ink path tube 4, opening/closing valve 5, and reservoir tank 6 shown in FIG. 1 is disposed in order to supply the ink liquid 3K.

In the second ink liquid supply tube 8-2, an ink supply system of the yellow (Y), which is a system separate from the black ink supply system and which is constituted of the ink tank 2, ink path tube 4, opening/closing valve 5, and reservoir tank 6 shown in FIG. 1, is disposed in order to supply the ink liquid 3K.

On each inner wall upper face 21a between the first and second body containers 15, 16, as shown in FIG. 3, a tilted face 22a, a horizontal face 22b, and a substantially convex upper face 22c are continuously formed from the tip part P toward the base part B. It is to be noted that FIG. 3 shows the tilted face 22a, horizontal face 22b, and substantially convex upper face 22c formed on the first body container 15.

Each tilted face 22a is formed by a gradient which rises from the tip part P toward the base part B.

Each tilt angle of the tilted face 22a with respect to the horizontal face at a time when the first and second body containers 15, 16 are horizontally disposed is formed to such an extent that each bubble extends along the tilted face 22a with a small frictional resistance and the bubble is lifted up by natural buoyancy.

At the time of image forming, each of inner ink liquid levels F of the first and second body containers 15, 16 is kept at a liquid level height which is higher than a height position connected to the first ink liquid supply tube 8-1 and second ink liquid supply tube 8-2 and which is lower than the horizontal face 22b. Therefore, the liquid level height of the ink liquid level F of each of the ink liquids 3K, 3Y in the first and second body containers 15, 16 is kept to be lower than that of the tilted face 22a of each of the first and second body containers 15, 16.

A top face of the substantially convex upper face 22c is formed to be higher than the horizontal face 22b in the base part B. Accordingly, bubble collecting space portions 23, 24 are formed in the base part B.

As shown in FIGS. 2 and 3, an atmosphere open tube 25 is disposed in the substantially convex upper face 22c of each of the bubble collecting space portions 23, 24. The atmosphere open tube 25 is disposed upwards. The atmosphere open tube 25 is provided with an atmosphere open valve 26. The respective atmosphere open valves 26 are opened when the ink liquids 3K, 3Y are supplied to the ink distributors 9 from the reservoir tanks 6, and when the ink liquids 3K, 3Y are supplied to the ink heads 12.

In the inner walls of the first and second body containers 15, 16, a plurality of bubble flow-regulating bubble paths 27, 28 are disposed. It is to be noted that FIG. 3 shows the only bubble flow-regulating bubble path 27 of the first body container 15.

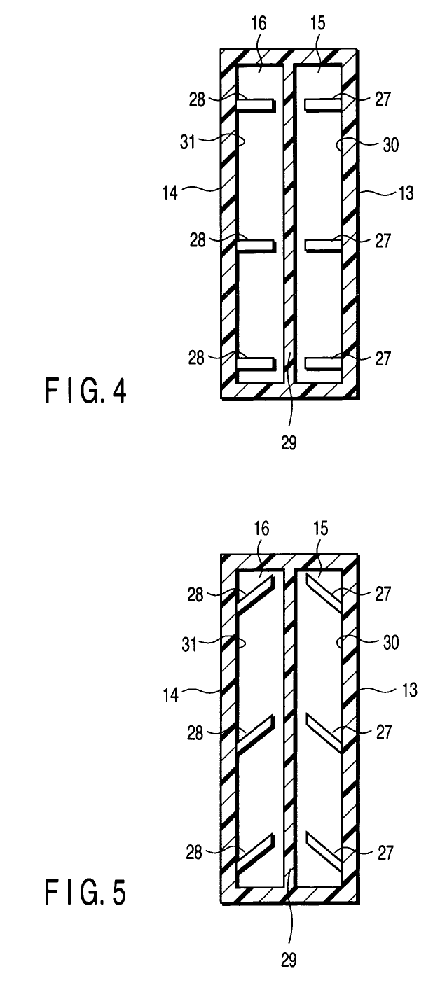

FIG. 4 shows a B-B sectional view in FIG. 3. The respective bubble flow-regulating bubble paths 27, 28 guide the bubbles mixed in the ink liquids 3K, 3Y in one direction, that is, on the side of the base part B connected to the atmosphere open tubes 25.

The bubble flow-regulating bubble path 27 is disposed opposite to the bubble flow-regulating bubble path 28, and the bubble paths are constituted of a plurality of mutually parallel linear and substantially convex portions. The respective bubble flow-regulating bubble paths 27, 28 are disposed on all the faces of the inner walls of the first and second body containers 15, 16. The bubble flow-regulating bubble paths 27, 28 are tilted with respect to the horizontal faces of the first and second body containers 15, 16.

Tilt angles of the bubble flow-regulating bubble paths 27, 28 are acute toward the base part B side from the tip part P side with respect to the horizontal faces. That is, the tilt angles of the bubble flow-regulating bubble paths 27, 28 are formed to such an extent that the bubbles mixed in the ink liquids 3K, 3Y are lifted up along the faces of the bubble flow-regulating bubble paths 27, 28 by small frictional resistance and natural buoyancy.

Intervals of the bubble flow-regulating bubble paths 27, 28 may be set in such a manner that the ink liquids 3K, 3Y are supplied downwards and the bubbles mixed in the ink liquids 3K, 3Y are lifted up along the faces of the bubble flow-regulating bubble paths 27, 28.

The intervals capable of lifting up the bubbles along the faces of the bubble flow-regulating bubble paths 27, 28 are associated with one or both of an interval of each of a plurality of mutually parallel bubble flow-regulating bubble paths in sizes of sectional areas of the bubble flow-regulating bubble paths 27, 28, and a protruding length of the substantially convex portion. The sectional areas of the bubble flow-regulating bubble paths 27, 28 are set in accordance with sizes of the bubbles mixed in the ink liquids 3 in the first and second body containers 15, 16. The sizes of the bubbles mixed in the ink liquids 3 in the first body container 15 and second body container 16 can be measured beforehand.

As shown in FIG. 4, the back face 29 of the first body container 15 is disposed opposite to that of the second body container 16. The bubble flow-regulating bubble paths 27, 28 are disposed on inner wall faces 30, 31 facing the back faces 29. The substantially convex portions of the bubble flow-regulating bubble paths 27, 28 protrude from the inner wall faces 30, 31 substantially in a vertical direction. It is to be noted that the respective bubble flow-regulating bubble paths 27, 28 may be protrusions turned upwards (obliquely upward direction) from the inner wall faces 30, 31, for example, as shown in FIG. 5.

Liquid level measuring sections 32, 33 are disposed on outer side faces of the first and second distributor units 13, 14 in the base part B. The liquid level measuring sections 32, 33 measure the liquid level heights of the ink liquids 3. The respective liquid level measuring sections 32, 33 are formed in such a manner as to protrude outwards from the outer side faces of the first and second distributor units 13, 14.

The respective liquid level measuring sections 32, 33 communicate with the first and second body containers 15, 16 to accommodate the ink liquids 3K, 3Y. For example, float switches 38, 39 are disposed as liquid level sensors for detecting the liquid level heights of the ink liquids 3K, 3Y in the liquid level measuring sections 32, 33. For example, a water level indicator or the like may be used in each liquid level sensor.

As shown in FIG. 3, the respective float switches 38, 39 detect the liquid levels on the liquid levels F of the ink liquids 3K, 3Y at the time of the image forming as shown in FIG. 3. Floats in the float switches 38, 39 float up by the ink liquids 3K, 3Y in the liquid level measuring sections 32, 33. The respective floats in the float switches 38, 39 move up or down in accordance with the liquid level heights of the ink liquids 3K, 3Y.

Therefore, the float switches 38, 39 output liquid level detection signals in accordance with the liquid level heights of the ink liquids 3K, 3Y.

When the liquid level heights of the ink liquids 3K, 3Y in the liquid level measuring sections 32, 33 are higher than the liquid levels F, the float switches 38, 39 output regulating signals of liquid level rise. The respective float switches 38, 39 may output regulating signals of liquid level drop, when the liquid level heights of the ink liquids 3K, 3Y in the liquid level measuring sections 32, 33 lower below the liquid levels F.

A heater 40 is disposed on a bottom part of each of the first and second distributor units 13, 14 from the tip part P before the base part B. The heater 40 heats the ink liquids 3K, 3Y stored in the first and second distributor units 13, 14.

That is, heat generated by the heater 40 is transferred to the ink liquids 3K, 3Y via the bottom faces of the first and second body containers 15, 16 in the first and second distributor units 13, 14, the inner wall faces 30, 31, and the substantially convex parts in the bubble flow-regulating bubble paths 27, 28.

The heater 40 is disposed in such a manner as to cover bottom parts of the first and second distributor units 13, 14 in consideration of heat convection of the ink liquids 3K, 3Y in the ink distributor 9.

In concrete arrangement of the heater 40, for example, heating wires are disposed in such a manner as to cover the bottom parts of the first and second distributor units 13, 14. The heater 40 is coated with a heat transfer member, and disposed in the bottom parts of the first and second distributor units 13, 14. The heater 40 coated with the heat transfer member is formed in a concave shape in such a manner as to cover the bottom parts of the first and second distributor units 13, 14. The heater 40 is disposed in such a manner as to cover peripheries of the respective ink discharge port groups 18-1 . . . 18-3 and 20-1 . . . 20-3. The heater 40 is disposed in the vicinity of the ink discharge port groups 18-1 . . . 18-3 and 20-1 . . . 20-3.

The heater 40 may be disposed in such a manner that all the faces of the bottom parts of the first and second distributor units 13, 14 are covered from each tip part P over to each base part B. The heater 40 may be disposed in such a manner as to cover all the faces of the first and second distributor units 13, 14. The heater 40 may be disposed only on the side face of each of the first and second distributor units 13, 14.

Next, a control system will be described.

An ink liquid supply control section 41 inputs one or both of the liquid level detection signals output from the float switches 38, 39, and judges whether or not the ink liquids 3K, 3Y are in the liquid level positions of the liquid levels F in one or both of the first and second distributor units 13, 14.

When it is judged that the ink liquids 3K, 3Y are in the liquid level positions of the liquid levels F, the ink liquid supply control section 41 issues a closing instruction to the corresponding opening/closing valve 5 corresponding to one or both of the first and second distributor units 13, 14.

When the ink liquid 3K is supplied to the first distributor unit 13 from the reservoir tank 6, the ink liquid supply control section 41 receives the liquid level detection signal of the liquid level F output from the float switch 38 to output a supply stop signal for stopping the supply of the ink liquid 3K. Accordingly, an instruction to close the opening/closing valve 5 corresponding to the ink liquid 3K is issued.

The liquid level F drops by consumption of the ink liquid 3K at the time of the image forming. The ink liquid supply control section 41 receives the liquid level detection signal of the liquid level F output from the float switch 38, when the liquid level lowers to the liquid level F at the time of the image forming to output a supply start signal for starting the supply of the ink liquid 3K into the reservoir tank. Accordingly, an instruction to open the opening/closing valve 5 corresponding to the ink liquid 3K is issued.

When the ink liquid 3Y is supplied to the second distributor unit 14 from the reservoir tank 6, the ink liquid supply control section 41 receives the liquid level detection signal of the liquid level F output from the float switch 38 to output the supply stop signal for stopping the supply of the ink liquid 3Y. Accordingly, an instruction to close the opening/closing valve 5 corresponding to the ink liquid 3Y is issued.

The liquid level F drops by the consumption of the ink liquid 3Y at the time of the image forming. The ink liquid supply control section 41 receives the liquid level detection signal of the liquid level F output from the float switch 38, when the liquid level lowers to the liquid level F at the time of the image forming to output a supply start signal for starting the supply of the ink liquid 3Y into the reservoir tank. Accordingly, an instruction to open the opening/closing valve 5 corresponding to the ink liquid 3Y is issued.

The ink liquid supply control section 41 informs that the ink liquids 3K, 3Y have predetermined liquid levels in one or both of the first and second distributor units 13, 14.

Concretely, the ink liquid supply control section 41 displays on a display that the ink liquids 3K, 3Y have predetermined liquid levels, or issues an alarm or the like.

A temperature sensor 42 is disposed on an outer upper face of the first and second distributor units 13, 14.

The temperature sensor 42 is installed on a boundary face (on the back face 29) between the first and second distributor units 13, 14, and in an intermediate part M between the tip part P and the base part B. The temperature sensor 42 detects the temperature of the first and second distributor units 13, 14, and outputs a temperature detection signal.

A temperature control section 43 inputs the temperature detection signal output from the temperature sensor 42, and energizes/controls the heater 40 in such a manner that the temperature of the first and second distributor units 13, 14 is controlled to be constant at a preset heating temperature.

Next, an operation of the ink distributor constituted as described above will be described.

The respective opening/closing valves 5 of the ink supply systems of, for example, black (K) and yellow (Y) are opened at the time of the image forming in the image forming apparatus of the ink jet system. The respective ink liquids 3K, 3Y stored in the ink tanks 2 of the ink supply systems are supplied to the reservoir tanks 6 through the ink path tubes 4. Accordingly, the pressure in each reservoir tank 6 rises. By the pressure rises in the respective reservoir tanks 6, the ink liquids 3K, 3Y in the reservoir tanks 6 are supplied to the ink distributors 9 through the ink liquid supply tubes 8-1, 8-2.

The ink liquid 3K supplied to the first distributor unit 13 is supplied to the ink heads 12 through the ink discharge port groups 18-1 . . . 18-3, ink inflow channels 10, and sealing mechanisms 11 of the ink channels. Each ink head 12 ejects the ink liquid 3K to the image forming medium 1 conveyed in the arrow A direction.

The ink liquid 3Y supplied to the second distributor unit 14 is supplied to the ink heads 12 through the ink discharge port groups 20-1 . . . 20-3, ink inflow channels 10, and sealing mechanisms 11 of the ink channels. Each ink head 12 ejects the ink liquid 3Y to the image forming medium 1 conveyed in the arrow A direction.

In general, the bubbles are mixed in the ink liquids 3K, 3Y of one or both of the black (K) and the yellow (Y) supplied from the reservoir tanks 6. The bubbles mixed in the ink liquids 3K, 3Y are mixed in the first distributor unit 13 and second distributor unit 14, respectively.

Although it is not the image forming time, for example, the bubbles floating up from the ink heads 12 exist. The bubbles floating up from the ink heads 12 are mixed into the first distributor unit 13 and second distributor unit 14 through the sealing mechanisms 11 of the ink channels, ink inflow channels 10, and ink discharge port groups 18-1 . . . 18-3, or 20-1 . . . 20-3.

The respective bubbles mixed in the first and second distributor units 13, 14 move upwards along the substantially convex portions of the bubble flow-regulating bubble paths 27, 28 by the natural buoyancy. Since the bubble flow-regulating bubble paths 27, 28 are disposed on all the faces of the inner walls of the first and second body containers 15, 16, the bubbles move upwards along the substantially convex portions of the bubble flow-regulating bubble paths 27, 28 without piling up in the ink discharge port groups 18-1 . . . 18-3, or 20-1 . . . 20-3.

In this state, the temperature control section 43 inputs the temperature detection signal output from the temperature sensor 42, and energizes/controls the heater 40 in such a manner that the temperatures of the first and second distributor units 13, 14 are controlled to be constant at the preset heating temperature. Accordingly, the heater 40 generates the heat at the above-described preset heating temperature.

The heat generated from the heater 40 is transferred to the ink liquids 3 via the outer walls of the first and second distributor units 13, 14, and the substantially convex portions of the bubble flow-regulating bubble paths 27, 28.

Accordingly, the first and second distributor units 13, 14 are heated at the preset heating temperature, and the ink liquids 3K, 3Y in the first and second distributor units 13, 14 are heated.

Since the heater 40 is disposed in the bottom parts of the first and second distributor units 13, 14, a temperature difference is accordingly generated between the ink liquids 3K, 3Y in the bottom parts and upper parts of the first and second distributor units 13, 14.

Accordingly, in the respective ink liquids 3K, 3Y in the bottom parts of the first and second distributor units 13, 14 heated by the heater 40, heat convection occurs in such a manner that the ink liquids 3K, 3Y move in upward directions and thereafter try to move in the bottom parts again.

The respective ink liquids 3K, 3Y flow obliquely upwards along the bubble flow-regulating bubble paths 27, 28, and thereafter flow toward the bottom parts of the first and second distributor units 13, 14.

That is, the respective ink liquids 3K, 3Y convectively flow in a clockwise direction on the sheet shown in FIG. 3 in the upper parts from the bottom parts of the first and second distributor units 13, 14.

Accordingly, the temperatures of the ink liquids 3 in the first and second distributor units 13, 14 are made uniform, and rising movements of the bubbles mixed in the ink liquids 3K, 3Y are activated. The rising movements of the bubbles mixed in the ink liquids 3K, 3Y along the substantially convex portions of the bubble flow-regulating bubble paths 27, 28 are speeded up.

Since the heater 40 is disposed in such a manner as to cover the ink discharge port groups 18-1 . . . 18-3 and 20-1 . . . 20-3, the bubbles rising/moving from the ink heads 12 via the sealing mechanisms 11, and bubbles mixed in the first and second distributor units 13, 14 from the ink discharge port groups 18-1 . . . 18-3, and 20-1 . . . 20-3 are moved upwards along the substantially convex portions of the bubble flow-regulating bubble paths 27, 28 faster than at ordinary temperatures.

The respective bubbles rising/moving along the bubble flow-regulating bubble paths 27, 28 reach the tilted faces 22a, horizontal faces 22b, and substantially convex upper faces 22c in the first and second distributor units 13, 14.

The respective bubbles which have reached the tilted face 22a move upward along the tilt of the tilted face 22a.

These bubbles impart pressing forces with respect to the bubbles existing on each horizontal face 22b by flowing forces of the rising along the tilt of the tilted face 22a. Accordingly, the bubbles which have reached the tilted face 22a and horizontal face 22b reach the substantially convex upper face 22c along the horizontal face 22b from the tilted face 22a. As a result, the respective bubbles are collected in the above-described bubble collecting space portions 23, 24.

The respective bubbles collected in the bubble collecting space portions 23, 24 are released to the atmosphere by opening the atmosphere open valves 26 via the atmosphere open tubes 25.

The ink distributors 9 which distribute the ink liquids 3K, 3Y have been described above, but ink distributors which distribute ink liquids 3C, 3M of the cyan (C) and magenta (M) are disposed in the image forming apparatus of the ink jet system. Since the ink distributors for distributing the ink liquids 3C, 3M have the same constitutions as those of the ink distributors 9 for distributing the ink liquids 3K, 3Y, description of the ink distributors 9 of the ink liquids 3C, 3M is omitted.

As described above, according to the above-described embodiment, a plurality of bubble flow-regulating bubble paths 27, 28 are disposed in the first and second distributor units 13, 14 of the image forming apparatus of the ink jet system, and the bubbles mixed in the ink liquids 3 are collected in the bubble collecting space portions 23, 24 by the bubble flow-regulating bubble paths 27, 28. Accordingly, even when the respective bubbles floating up from the ink head 12 side are mixed in the first and second distributor units 13, 14, the bubbles can be quickly collected in the bubble collecting space portions 23, 24 and discharged to the atmosphere.

Additionally, a simple constitution can be realized in which the only bubble flow-regulating bubble paths 27, 28 are disposed in the first and second distributor units 13, 14.

The heater 40 is energized/controlled to heat the ink liquid 3 via the bottom parts of the first and second distributor units 13, 14. When the heat convection is generated in the ink liquids 3, and the rising movements of the bubbles mixed in the ink liquids 3 are activated, speeds for the rising movements along the bubble flow-regulating bubble paths 27, 28 can be set to be higher than at ordinary temperatures.

Accordingly, removal of each bubble in the first and second distributor units 13, 14 is promoted.

The heater 40 is disposed in such a manner as to cover the ink discharge port groups 18-1 . . . 18-3 and 20-1 . . . 20-3. The respective bubbles moved upwards from the ink heads 12 through the sealing mechanisms 11, and the bubbles mixed in the first and second distributor units 13, 14 from the ink discharge port groups 18-1 . . . 18-3 and 20-1 . . . 20-3 can be quickly removed.

Since the heat radiated from the heater 40 is transferred into the ink liquid 3 via the bottom faces of the first and second body containers 15, 16, the inner wall faces 30, 31, and the substantially convex portions in the bubble flow-regulating bubble paths 27, 28 in the first and second distributor units 13, 14, a heat transfer area with respect to the ink liquid 3 is large. Accordingly, the heat can be efficiently transferred into the ink liquid 3, and the removing of the bubbles can be speeded up.

As described above, even when the respective bubbles flow into the first and second distributor units 13, 14, the bubbles can be securely and quickly removed.

As a result, the respective ink liquids mixed with the bubbles can be inhibited from being supplied to the ink heads 12 at the time of an image forming operation. Accordingly, the ink head 12 is capable of stably ejecting the ink liquid 3 to the above-described image forming apparatus as set.

In the ink distributor 9, the back face of the first distributor unit 13 is disposed opposite and parallel to that of the second distributor unit 14, in which each of the ink liquids 3 of, for example, the black (K) and yellow (Y) is stored. Accordingly, one heater 40 may be disposed in such a manner as to cover the bottom parts of the first and second distributor units 13, 14 together.

One temperature sensor 42 is disposed on the outer wall upper part of the back face 29 of the first and second distributor units 13, 14. Accordingly, constitutions of and around the ink distributor 9 can be miniaturized, and space saving can be realized.

When the ink liquid 3 of one or both of the first and second distributor units 13, 14 has the predetermined liquid level height, the liquid level detection signal of one or both of the float switches 38, 39 is output. Accordingly, it can be reported that the ink liquid 3 of one or both of the first and second distributor units 13, 14 has the predetermined liquid level height.

When the ink liquid 3 of one or both of the first and second distributor units 13, 14 lowers below the predetermined liquid level height, the liquid level detection signal of one or both of the float switches 38, 39 is output. Accordingly, it can be reported that the ink liquid 3 in one or both of the first and second distributor units 13, 14 lowers below the predetermined liquid level height.

The respective bubble flow-regulating bubble paths 27, 28 supply not only the bubbles but also the ink liquids 3 downwards from the first and second distributor units 13, 14 with a small channel resistance. Therefore, the ink liquid 3 can be supplied into each ink head 12 through the ink distributor 9 having the small channel resistance. Accordingly, a pressure loss of the ink liquid 3 can be reduced and made uniform in each ink path between the ink distributor 9 and the ink head 12.

It is to be noted that the present invention is not limited to the above-described embodiment, and may be modified as follows.

For example, instead of storing ink liquids 3 of different colors, the same color of ink liquid 3 may be stored in the first and second distributor units 13, 14 of the ink distributor 9.

For example, the present invention is not limited to the embodiment in which the tilted face 22a is disposed on the upper face of the ink distributor 9 only on the tip part P.

For example, the tilted face 22a may be disposed entirely from the tip part P over to the base part B in the ink distributor 9, or the tilted face 22a may be disposed on the inner upper face of the first and second body containers 15, 16.

For example, an outward appearance of the ink distributor 9 does not have to be tilted in accordance with the tilted face 22a.

For example, the respective bubble flow-regulating bubble paths 27, 28 may be disposed only in the vicinity of at least ink discharge port groups 18-1 . . . 18-3 and 20-1 . . . 20-3.

For example, shapes of the bubble flow-regulating bubble paths 27, 28 may be formed by triangular prisms.

For example, the shapes of the bubble flow-regulating bubble paths 27, 28 may be bent into circular shapes.

For example, the respective bubble flow-regulating bubble paths 27, 28 may be formed in such a manner as to introduce the bubbles into the bubble collecting space portions 23, 24 of the first and second distributor units 13, 14.

For example, the respective bubble flow-regulating bubble paths 27, 28 may be disposed in opposite wall faces facing each other in the first and second body containers 15, 16.

For example, the heater 40 may be disposed only in the vicinity of at least ink discharge port groups 18-1 . . . 18-3 and 20-1 . . . 20-3.

For example, the present invention is not limited to the embodiment in which the temperature sensor 42 is disposed on the upper faces of the first and second distributor units 13, 14, and the sensor may be disposed anywhere on the outer wall face of the above-described back face 29 on which the temperature of the ink liquid 3 can be detected.

Moreover, the number of temperature sensors 42 may be arbitrarily changed, and may be disposed, for example, on arbitrary positions of the first and second distributor units 13, 14.

For example, the ink distributor 9 is not limited to the ink distributor 9 of the image forming apparatus of the ink jet system, and may be applied to general containers whose bubbles need to be securely and quickly removed and which accommodate the ink liquids 3.

For example, the ink distributor 9 is not limited to parallel arrangement of the first and second distributor units 13, 14, and may have one distributor unit. In this case, the ink distributor 9 is required for each of the single-color ink liquids 3 of black (K), cyan (C), magenta (M), and yellow (Y).

1. An ink distributor comprising:
an ink distributor body which allows an ink liquid to communicate with at least one ink head that ejects the ink liquid and which accommodates the ink liquid and which supplies the ink liquid to at least one ink head; and
a bubble flow-regulating bubble path which is disposed in the ink distributor body and which regulates a flow direction of bubbles mixing in the ink liquid.

2. The ink distributor according to claim 1, wherein the bubble flow-regulating bubble path regulates a direction in which the bubbles flow as an upward direction, and introduces the bubbles into an upper part of the ink distributor body.

3. The ink distributor according to claim 1, wherein the bubble flow-regulating bubble path has a plurality of bubble paths disposed with parallel to one another positions of each other, and disposed in a tilted direction with respect to a horizontal direction of the ink distributor body.

4. The ink distributor according to claim 1, wherein the bubble flow-regulating bubble path has a plurality of mutually parallel and substantially correct convex portions; and
the plurality of substantially correct convex portions are tilted with respect to the horizontal direction, and disposed on inner wall faces of the ink distributor body.

5. The ink distributor according to claim 1, wherein the bubble flow-regulating bubble path has regulating of a face, and is disposed at such a tilt angle that the bubbles move along the regulating face with a small frictional resistance and move upwards by natural buoyancy.

6. The ink distributor according to claim 4, wherein the plurality of substantially correct convex portions are disposed in a vertical direction with respect to the inner wall face of the ink distributor body.

7. The ink distributor according to claim 4, wherein the plurality of substantially correct convex portions are disposed at an acute angle with respect to the inner wall face of the ink distributor body, and tilting upwards.

8. The ink distributor according to claim 1, wherein an inner wall face upper of the ink distributor body is tilting with respect to a horizontal direction of the ink distributor body.

9. The ink distributor according to claim 8, wherein the inner wall face upper of the ink distributor body is disposed at such a tilt angle that the bubbles moving along the inner wall face upper with a small frictional resistance and the bubbles move up by natural buoyancy.

10. The ink distributor according to claim 1, wherein a predetermined interval is disposed between an inner wall face upper of the ink distributor body and an upper end portion of the bubble flow-regulating bubble path, and a bubble flow passage for circulating the bubbles is formed between the inner wall face upper and the upper end portion.

11. The ink distributor according to claim 1, further comprising:
a bubble collecting space portion which is disposed in an upper part of the ink distributor body and which collects bubbles introduced into the upper part of the ink distributor body through the bubble flow-regulating bubble path.

12. The ink distributor according to claim 11, further comprising:
an atmosphere open system which is disposed in the bubble collecting space portion and which releases bubbles collected in the bubble collecting space portion to an atmosphere.

13. The ink distributor according to claim 12, wherein the atmosphere open system has:
an atmosphere open tube disposed in the bubble collecting space portion; and
an atmosphere open valve disposed on the atmosphere open tube.

14. The ink distributor according to claim 1, further comprising:
at least one liquid level sensor which detects a liquid level height of the ink liquid stored in the ink distributor body;
an ink liquid supply system which supplies the ink liquid into the ink distributor body; and
an ink liquid supply control section which regulates an amount of the ink liquid supplied into the ink distributor body from the ink liquid supply system based on the liquid level height detected by the liquid level sensor.

15. The ink distributor according to claim 14, wherein the liquid level sensor detects that the liquid level of the ink liquid stored in the ink distributor body is a predetermined liquid level height.

16. The ink distributor according to claim 14, further comprising:
a liquid level measuring section is protruding outwards from an outer side face of the ink distributor body,
wherein the liquid level sensor is disposed in the liquid level measuring section.

17. The ink distributor according to claim 1, further comprising:
a heating section which is disposed in a bottom part of the ink distributor body and which heats the ink liquid storing in the ink distributor body.

18. The ink distributor according to claim 17, wherein the heating section has a heater.

19. The ink distributor according to claim 17, wherein the ink distributor body has an ink discharge port which supplies the ink liquid to at least one ink head, and
the heating section is disposed in the vicinity of the ink discharge port.

20. The ink distributor according to claim 1, wherein the bubble flow-regulating bubble path has a plurality of substantially correct convex portions which are disposed on an inner wall face of the ink distributor body and which are tilted with respect to a horizontal direction of the ink distributor body and which are parallel positions of other,
the ink distributor body has a heating section disposed in a bottom part thereof; and
the heating section heats the ink liquid via the plurality of substantially correct convex portions disposed on an inner wall of the ink distributor body.

21. The ink distributor according to claim 17, further comprising:
at least one temperature sensor which detects a temperature of the ink distributor body; and
a temperature control section which controls heating by the heating section in accordance with a temperature of the ink distributor body detected by the temperature sensor.

22. The ink distributor according to claim 21, wherein the heating section has a heater, and
the temperature control section energizes/controls the heater.

23. The ink distributor according to claim 18, wherein the heater is disposed in such a manner as to cover the whole bottom part of the ink distributor body.

24. The ink distributor according to claim 1, wherein the ink distributor body has two distributor units.

25. The ink distributor according to claim 1, further comprising:
a plurality of ink discharge ports which are disposed in the ink distributor body and which discharge the ink liquid;
ink heads disposed as many as the plurality of ink discharge ports; and
a plurality of ink paths communicating between the plurality of ink discharge ports and the ink heads,
the plurality of ink paths having equal ink path lengths.
